(19) United States
(12) Patent Application Publication
(10) Pub. No.: US 2026/0202073 A1
(43) Pub. Date: Jul. 16, 2026

(54) AIR-CONDITIONING APPARATUS

(71) Applicant: Mitsubishi Electric Corporation, Tokyo (JP)

(72) Inventors: Kota MORIMOTO, Tokyo (JP); Kazuhisa IWASAKI, Tokyo (JP); Kazuyuki MATSUDA, Tokyo (JP)

(21) Appl. No.: 19/134,627

(22) PCT Filed: Feb. 1, 2023
(86) PCT No.: PCT/JP2023/003223

§ 371 Date: May 30, 2025

(51) Int. Cl. F24F 11/46; F24F 3/14; F24F 11/86

(52) U.S. Cl. CPC F24F 11/46; F24F 3/14; F24F 11/86; F24F 2003/1446

(57) ABSTRACT

An air-conditioning apparatus provided with an outdoor unit that has a compressor and an indoor unit installed in an air-conditioning target space is provided with an indoor fan that is installed in the indoor unit and sends out air to the air-conditioning target space, an indoor fan motor that is installed in the indoor unit and drives the indoor fan, and a controller that controls the indoor fan motor and the compressor. During a dehumidifying operation, the controller performs a first control in which the rotational speed of the indoor fan motor and the operating frequency of the compressor are controlled such that the sensible heat ratio of the indoor unit matches a target sensible heat ratio and then performs a second control in which the operating frequency of the compressor is controlled such that the capacity value of the indoor unit matches a target capacity value.

### TECHNICAL FIELD

The present disclosure relates to an air-conditioning apparatus that performs a dehumidifying operation.

### BACKGROUND ART

Some air-conditioning apparatus dehumidifies an air-conditioning target space (refer to, for example, Patent Literature 1). An air-conditioning apparatus described in Patent Literature 1 starts a dehumidifying operation in a case where the relative humidity in an air-conditioning target space is higher than a preset upper limit relative humidity. The air-conditioning apparatus described in Patent Literature 1 is designed to increase the operating frequency of the compressor during the dehumidifying operation by lowering the target value for the evaporating temperature, as well as by decreasing the rotational speed of the indoor unit fan to the minimum rotational speed. The air-conditioning apparatus described in Patent Literature 1 is designed to improve the comfort in a room by lowering the target value for the evaporating temperature and as a result, reducing the relative humidity in the air-conditioning target space.

### CITATION LIST

### Patent Literature

Patent Literature 1: Japanese Unexamined Patent Application Publication No. 2016-8742

### SUMMARY OF INVENTION

### Technical Problem

The air-conditioning apparatus described in Patent Literature 1 is designed to improve the comfort in a room by reducing the relative humidity in the air-conditioning target space. However, although the air-conditioning apparatus described in Patent Literature 1 adjusts the rotational speed of the indoor unit fan and the evaporating temperature, it does not adjust the operating capacity, so the operating capacity is left to be determined passively. As a result, the air-conditioning apparatus described in Patent Literature 1 may lead to an unnecessarily large operating capacity and may thus fail to reduce power consumption. That is, it is undesirably difficult for the air-conditioning apparatus described in Patent Literature 1 to achieve both improved comfort and reduced power consumption during a dehumidifying operation.

The present disclosure aims to solve the above problems and an object of the present disclosure is to provide an air-conditioning apparatus that achieves both improved comfort and reduced power consumption during a dehumidifying operation.

### Solution to Problem

An air-conditioning apparatus according to an embodiment of the present disclosure, which is provided with an outdoor unit that has a compressor and an outdoor heat exchanger and an indoor unit that is installed in an air-conditioning target space and has an indoor heat exchanger, is provided with an indoor fan installed in the indoor unit and configured to send out air to the air-conditioning target space, an indoor fan motor installed in the indoor unit and configured to drive the indoor fan, and a controller configured to control the indoor fan motor and the compressor. During a dehumidifying operation in which the outdoor heat exchanger is caused to serve as a condenser and the indoor heat exchanger is caused to serve as an evaporator, the controller is configured to perform a first control in which a rotational speed of the indoor fan motor and an operating frequency of the compressor are controlled such that a sensible heat ratio of the indoor unit matches a target sensible heat ratio, which is set in advance, and is then configured to perform a second control in which the operating frequency of the compressor is controlled such that a capacity value of the indoor unit matches a target capacity value, which is set in advance.

### Advantageous

An air-conditioning apparatus according to an embodiment of the present disclosure performs a first control and a second control and thus controls an indoor fan motor and a compressor such that a sensible heat ratio of an indoor unit matches a target sensible heat ratio and a capacity value of the indoor unit matches a target capacity value. Therefore, the air-conditioning apparatus achieves both improved comfort and reduced power consumption during a dehumidifying operation.

### BRIEF DESCRIPTION OF DRAWINGS

FIG. 1 is a block diagram that illustrates the configuration of an air-conditioning apparatus according to Embodiment 1.

FIG. 2 is a control block diagram that illustrates the control configuration of the air-conditioning apparatus according to Embodiment 1.

FIG. 3 is a psychrometric chart during a dehumidifying operation of the air-conditioning apparatus according to Embodiment 1.

FIG. 4 is a flowchart that illustrates a first control in a dehumidifying operation of the air-conditioning apparatus according to Embodiment 1.

FIG. 5 is a flowchart that illustrates a second control in a dehumidifying operation of the air-conditioning apparatus according to Embodiment 1.

FIG. 6 is a time chart that illustrates the sensible heat ratio and the capacity value of an indoor unit, the rotational speed of an indoor fan motor, and the operating frequency of a compressor in a dehumidifying operation of the air-conditioning apparatus according to Embodiment 1.

FIG. 7 is a diagram that illustrates the configuration of an air-conditioning apparatus according to Embodiment 2.

FIG. 8 is a control block diagram that illustrates the control configuration of the air-conditioning apparatus according to Embodiment 2.

FIG. 9 is a flowchart that illustrates a first process in a first control in a dehumidifying operation of the air-conditioning apparatus according to Embodiment 2.

FIG. 10 is a flowchart that illustrates a second process in the first control in a dehumidifying operation of the air-conditioning apparatus according to Embodiment 2.

FIG. 11 is a flowchart that illustrates a second control in a dehumidifying operation of the air-conditioning apparatus according to Embodiment 2.

### DESCRIPTION OF EMBODIMENTS

Embodiments of the present disclosure are described below with reference to drawings. Note that the same or equivalent elements are denoted by the same reference signs in the drawings. Their descriptions are omitted or simplified as long as resultant descriptions are suited.

### Embodiment 1

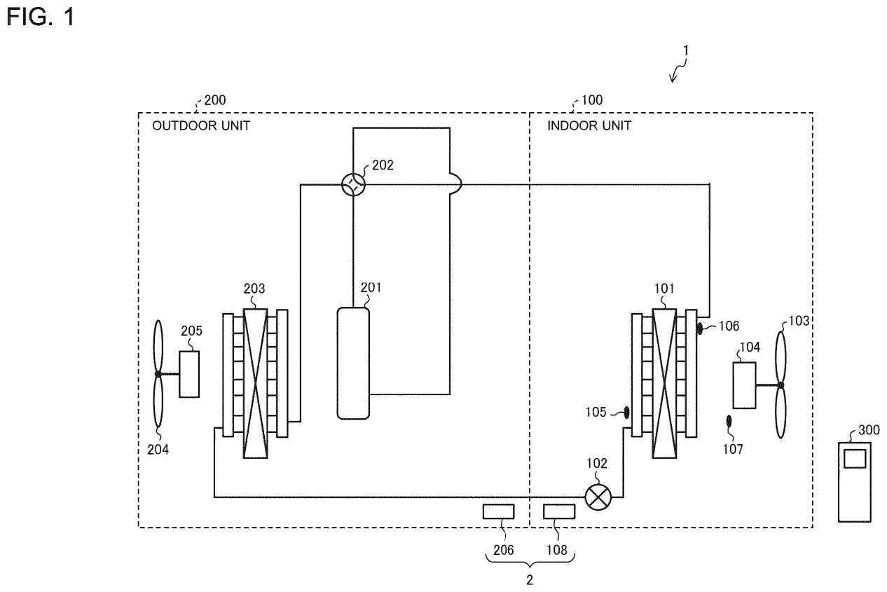

FIG. 1 is a block diagram that illustrates the configuration of an air-conditioning apparatus 1 according to Embodiment 1. The air-conditioning apparatus 1 is provided with an indoor unit 100 and an outdoor unit 200. The indoor unit 100 is provided with an indoor heat exchanger 101, a pressure reducing device 102, an indoor fan 103, and an indoor fan motor 104. The outdoor unit 200 is provided with a compressor 201, a four-way valve 202, an outdoor heat exchanger 203, an outdoor fan 204, and an outdoor fan motor 205. The air-conditioning apparatus 1 forms a refrigerant circuit in which the compressor 201, the four-way valve 202, the outdoor heat exchanger 203, the pressure reducing device 102, and the indoor heat exchanger 101 are connected to each other by refrigerant pipes and through which refrigerant circulates.

The indoor heat exchanger 101 is, for example, a fin-and-tube heat exchanger, which has a heat transfer tube and a plurality of fins.

The pressure reducing device 102, which is, for example, an electronic expansion valve, adjusts the flow rate of refrigerant by having its opening degree set, and reduces the pressure of refrigerant and expands the refrigerant by serving as a pressure reducing valve or an expansion valve.

The indoor fan 103 is a fan that sends out air to an air-conditioning target space in which the indoor unit 100 is installed. The fan is, for example, a propeller fan, a turbo fan, and sirocco fan. The indoor fan motor 104 drives the indoor fan 103 to rotate. The indoor fan motor 104 is configured to adjust the amount of air by varying the rotational speed.

The compressor 201 sucks in refrigerant and compresses the sucked-in refrigerant into a high-temperature and high-pressure state. The compressor 201 is a volumetric displacement compressor provided with an inverter device (not illustrated) and configured to vary the operating frequency.

The four-way valve 202 switches between a cooling operation and a heating operation by switching flow directions of refrigerant in the refrigerant circuit.

The outdoor heat exchanger 203 is, for example, a fin-and-tube heat exchanger, which has a heat transfer tube and a plurality of fins.

The outdoor fan 204 is a fan that sends out air to outdoor space. The fan is, for example, a propeller fan, a turbo fan, and sirocco fan. The outdoor fan motor 205 drives the outdoor fan 204 to rotate. The outdoor fan motor 205 is configured to adjust the amount of air by varying the rotational speed.

The air-conditioning apparatus 1 thus described above is configured to perform a dehumidifying operation, a cooling operation, and a heating operation with the four-way valve 202 switched. In a case where the four-way valve 202 is switched to solid lines illustrated in FIG. 1, the indoor heat exchanger 101 serves as an evaporator and the outdoor heat exchanger 203 serves as a condenser and a dehumidifying operation or a cooling operation is performed. In a case where the four-way valve 202 is switched to dashed lines illustrated in FIG. 1, the indoor heat exchanger 101 serves as a condenser and the outdoor heat exchanger 203 serves as an evaporator and a heating operation is performed. Note that the air-conditioning apparatus 1 needs only to enable a dehumidifying operation and the four-way valve 202 is not an essential component and may thus be omitted.

Next, a plurality of sensors, a controller 2, and a remote control 300 provided to the air-conditioning apparatus 1 are described.

The indoor unit 100 is provided with a liquid pipe temperature sensor 105, which measures the temperature of refrigerant that flows into the indoor heat exchanger 101 during a dehumidifying operation or a cooling operation, and a gas pipe temperature sensor 106, which measures the temperature of refrigerant that flows out from the indoor heat exchanger 101 during a cooling operation. Also, the indoor unit 100 is provided with a suction temperature sensor 107, which measures the temperature of indoor air sucked into the indoor unit 100 (hereinafter referred to as a suction temperature). These temperature sensors each output a temperature signal that corresponds to the measured temperature. These temperature sensors are, for example, thermistors.

Also, the air-conditioning apparatus 1 is provided with the controller 2, which controls the entirety of the air-conditioning apparatus 1. The controller 2 performs an operation instructed from the remote control 300. The controller 2 controls the indoor unit 100 and the outdoor unit 200 and the air-conditioning apparatus 1 consequently performs a dehumidifying operation, a cooling operation, or a heating operation. In particular, in a dehumidifying operation, the air-conditioning apparatus 1 achieves both comfort improved by dehumidification and reduced power consumption. Details of the dehumidifying operation are described later.

The controller 2 has an indoor controller 108 installed in the indoor unit 100 and an outdoor controller 206 installed in the outdoor unit 200. The indoor controller 108 and the outdoor controller 206 are connected to each other by a communication line such that data is communicable between them. The indoor controller 108 and the outdoor controller 206 are, for example, microprocessors. Note that the components of the indoor controller 108 and the outdoor controller 206 are not limited to the above. For example, the indoor controller 108 and the outdoor controller 206 may also be pieces of firmware or other updatable components. Also, the indoor controller 108 and the outdoor controller 206 may also be program modules executed in accordance with a command from an unillustrated CPU or another similar component.

The indoor controller 108 controls, for example, the rotational speed of the indoor fan motor 104 included in the indoor unit 100 according to the temperatures measured by the liquid pipe temperature sensor 105, the gas pipe temperature sensor 106, and the suction temperature sensor 107 and a setting specified by the remote control 300. The outdoor controller 206 controls the rotational speed of the outdoor fan motor 205 included in the outdoor unit 200 and the operating frequency of the compressor 201 included in the outdoor unit 200.

The remote control 300 is an input device that allows a user to input a command to the air-conditioning apparatus 1. The remote control 300 sends and receives various signals to and from the indoor controller 108. The remote control 300 is equipped with components such as a push button, a touch screen, a liquid crystal display, and a light-emitting diode (LED). A user operates the remote control 300 and thus inputs a command to the indoor unit 100. The command described above relates, for example, to factors such as an operation mode, a set temperature, a set humidity, the amount of air, and the orientation of air. The air-conditioning apparatus 1 operates in accordance with an input command. Note that the air-conditioning apparatus 1 may also use, as such a user interface, an information device such as a smartphone and a tablet instead of the remote control 300.

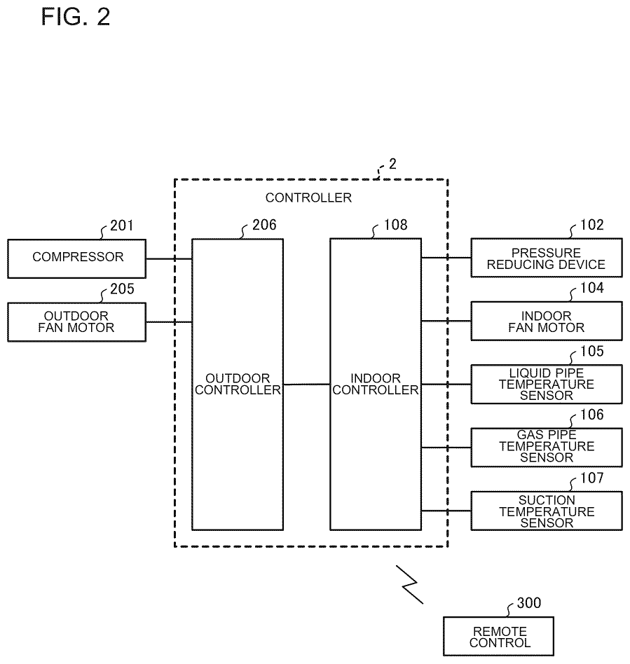

FIG. 2 is a control block diagram that illustrates the control configuration of the air-conditioning apparatus 1 according to Embodiment 1. To the indoor controller 108, the pressure reducing device 102 and the indoor fan motor 104 are connected.

Also, the liquid pipe temperature sensor 105, the gas pipe temperature sensor 106, and the suction temperature sensor 107 are connected to the indoor controller 108, which thus receives input temperature signals output from these temperature sensors. Also, the indoor controller 108 is connected to the remote control 300 such that they are communicable with each other. To the outdoor controller 206, the compressor 201 and the outdoor fan motor 205 are connected.

### Refrigeration Cycle Operation During Dehumidifying Operation

In a dehumidifying operation, the four-way valve 202 is switched to a state indicated by the solid lines illustrated in FIG. 1. The refrigerant compressed in the compressor 201 turns into high-temperature and high-pressure gas refrigerant, passes through the four-way valve 202, and flows into the outdoor heat exchanger 203. Refrigerant that flows into the outdoor heat exchanger 203 exchanges heat with outdoor air sent by the outdoor fan 204 and liquefies through heat rejection. The refrigerant that has liquefied is depressurized in the pressure reducing device 102 into a two-phase gas-liquid state and flows into the indoor heat exchanger 101. Refrigerant that flows into the indoor heat exchanger 101 exchanges heat with indoor air sent by the indoor fan 103 and gasifies through heat absorption. At this time, air inside the air-conditioning target space in which the indoor unit 100 is installed is cooled to the dew point temperature or lower through heat exchange with refrigerant inside the indoor heat exchanger 101 and the moisture in the air thus condenses on a surface of the indoor heat exchanger 101. Thus, the air-conditioning target space is dehumidified. The refrigerant that has gasified in the indoor heat exchanger 101 is returned to the compressor 201. As described above, refrigerant circulates in the refrigerant circuit and the air-conditioning target space is dehumidified.

### Overview of Dehumidifying Operation Control

Next, an overview of control of a dehumidifying operation aimed at achieving both improved comfort and reduced power consumption is described below. During a dehumidifying operation, the air-conditioning apparatus 1 performs a first control in which the rotational speed of the indoor fan motor 104 and the operating frequency of the compressor 201 are controlled such that a sensible heat ratio of the indoor unit 100 matches a target sensible heat ratio and a second control in which the compressor 201 is controlled such that a capacity value matches a target capacity value. The air-conditioning apparatus 1 repeatedly performs the first control and the second control so that the sensible heat ratio of the indoor unit 100 matches the target sensible heat ratio and the capacity value also matches the target capacity value. Here, the sensible heat ratio refers to the ratio of the amount of sensible heat to total heat, which is the sum of latent heat and the sensible heat and is expressed as sensible heat/(sensible heat+latent heat).

The target sensible heat ratio need only be set to a sensible heat ratio at which comfort is obtainable in accordance with an operational policy of a system and its extent is not limited. Also, the target capacity value is set according to the type of the indoor unit 100 and is set to a capacity value at which the effect of reducing power consumption is obtainable. The indoor units 100 differ from each other in that each type has its own factors such as a combination of the size of the indoor heat exchanger 101, the size of the indoor fan 103, and the capacity of the indoor fan motor 104. The target capacity value is thus set for each type. The target sensible heat ratio and the target capacity value are stored in the controller 2 in advance. Note that the target sensible heat ratio and the target capacity value may also be changed by a user through the remote control 300. The target sensible heat ratio is lowered in a case where a dehumidifying capacity is desired to be large and is raised in a case where a dehumidifying capacity is desired to be small. By providing guidance to users through, for example, an operation manual on such changes in dehumidifying capacity by adjustment of the target sensible heat ratio, the air-conditioning apparatus 1 meets the needs of users who require changes in dehumidifying capacity.

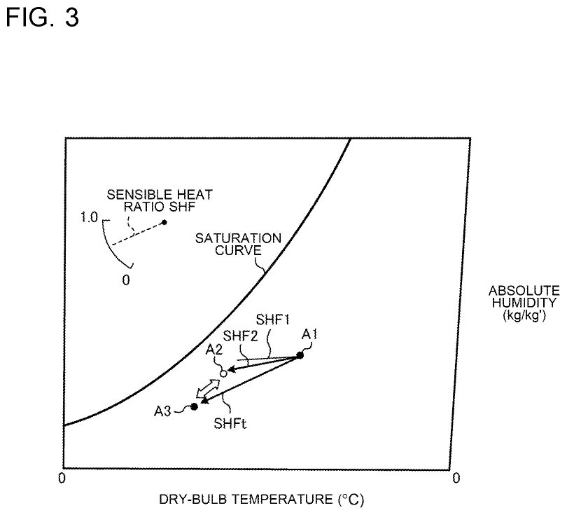

FIG. 3 is a psychrometric chart during a dehumidifying operation of the air-conditioning apparatus 1 according to Embodiment 1. In FIG. 3, the vertical axis represents absolute humidity (kg/kg′) and the horizontal axis represents dry-bulb temperature (degrees Celsius). Also, FIG. 3 illustrates a sensible heat ratio SHF, a saturation curve, and other related data. The sensible heat ratio SHF is higher when the slope of the straight line is gentle, and lower when the slope of the straight line is steep. In a case where the straight line is horizontal, the sensible heat ratio SHF is the maximum value, which is 1. Points A1, A2, and A3 illustrated in FIG. 3 represent state points specified by temperature and humidity.

An example is described below in which an air state in the air-conditioning target space changes through a dehumidifying operation with reference to FIG. 3. Here, as a simple example, an example is described in which the air-conditioning apparatus 1 performs the first control and the second control once each so that the sensible heat ratio reaches the target sensible heat ratio and the capacity value also reaches the target capacity value.

The state point A1 illustrated in FIG. 3 is a current state point in the air-conditioning target space. The current state point A1 is identified from the suction temperature measured by the suction temperature sensor 107 and a relative humidity set in advance. The “relative humidity set in advance” is set to, for example, the relative humidity under standard cooling conditions (such as 46.6%). The “relative humidity set in advance” is referred to below as set relative humidity.

The air-conditioning apparatus 1 first controls, as the first control, the indoor fan motor 104 and the compressor 201 such that the sensible heat ratio of the indoor unit 100 matches the target sensible heat ratio. Specifically, the air-conditioning apparatus 1 performs the first control with the aim of moving the current state point A1 in the air-conditioning target space onto the straight line of the target sensible heat ratio SHFt, which extends from the state point A1. The sensible heat ratio of the indoor unit 100 is calculable from the suction temperature measured by the suction temperature sensor 107, a liquid pipe temperature measured by the liquid pipe temperature sensor 105, and the rotational speed of the indoor fan motor 104. The air-conditioning apparatus 1 calculates the sensible heat ratio by use of the suction temperature, the liquid pipe temperature, the rotational speed of the indoor fan motor 104, the set relative humidity, and a calculation formula, a table, or other reference set in advance for calculating the sensible heat ratio.

The air state in the air-conditioning target space changes from the state point A1 to the state point A2 due to the first control, the absolute humidity decreases, and, as a result, the air-conditioning target space is dehumidified. Also, the first control causes the sensible heat ratio to change from a sensible heat ratio SHF1 to a sensible heat ratio SHF2 and approach the target sensible heat ratio SHFt.

Subsequently, the air-conditioning apparatus 1 controls, as the second control, the compressor 201 such that the capacity value matches the target capacity value. The capacity value is, similarly to the sensible heat ratio, calculable from the suction temperature measured by the suction temperature sensor 107, the liquid pipe temperature measured by the liquid pipe temperature sensor 105, and the rotational speed of the indoor fan motor 104. The air-conditioning apparatus 1 calculates the capacity value by use of the suction temperature, the liquid pipe temperature, the rotational speed of the indoor fan motor 104, the set relative humidity, and a calculation formula, a table, or other reference set in advance for calculating the capacity value.

The air state in the air-conditioning target space changes from the state point A2 to the state point A3 due to the second control, the absolute humidity further decreases, and, as a result, the air-conditioning target space is dehumidified. Also, the second control causes the sensible heat ratio to decrease from SHF2 and reach the target sensible heat ratio SHFt. That is, the air-conditioning apparatus 1 enables the sensible heat ratio of the indoor unit 100 to reach the target sensible heat ratio through the first control and the second control. Also, the air-conditioning apparatus 1 enables the capacity value to reach the target capacity value by controlling the compressor 201 through the second control. Such data are not illustrated in FIG. 3.

As described above, the air-conditioning apparatus 1 performs the first control and the second control such that the sensible heat ratio reaches the target sensible heat ratio and the capacity value also reaches the target capacity value and thereby achieves both improved comfort and reduced power consumption in a dehumidifying operation.

### Control Operation of Apparatus During Dehumidifying Operation

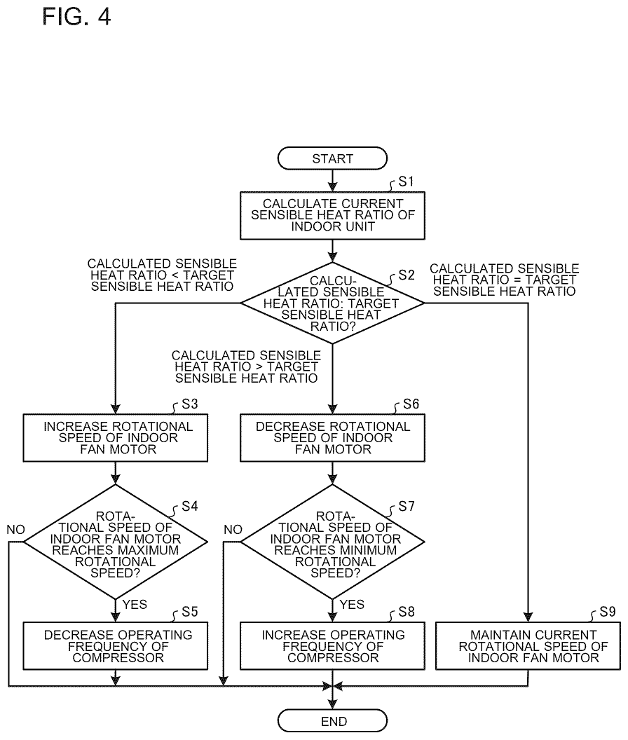

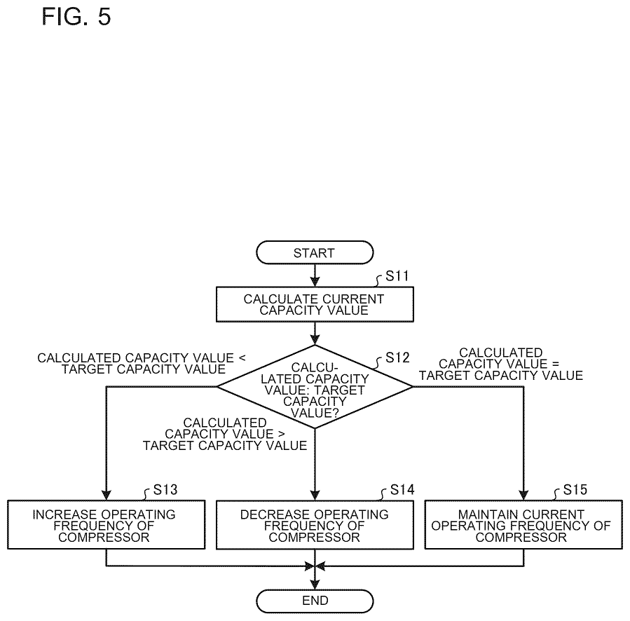

FIG. 4 is a flowchart that illustrates the first control in a dehumidifying operation of the air-conditioning apparatus 1 according to Embodiment 1. FIG. 5 is a flowchart that illustrates the second control in a dehumidifying operation of the air-conditioning apparatus 1 according to Embodiment 1. Processes described in the flowcharts illustrated in FIG. 4 and FIG. 5 are repeated at each control interval (for example, every minute). Note that the processes below are performed with communication between the indoor controller 108 and the outdoor controller 206 as necessary; however, the processes are described below as being performed by the controller 2 without the indoor controller 108 and the outdoor controller 206 distinguished from each other.

### First Control

The controller 2 starts a dehumidifying operation by driving related devices in the air-conditioning apparatus 1 when a dehumidifying operation is instructed from the remote control 300. Then, the controller 2 calculates the current sensible heat ratio of the air-conditioning target space through the same method described above (step S1). The controller 2 compares the calculated sensible heat ratio with the target sensible heat ratio, which is set in advance, (step S2) and controls the rotational speed of the indoor fan motor 104 according to a comparison result as described below (step S3, step S6, and step S9). Here, the sensible heat ratio is higher when the rotational speed of the indoor fan motor 104 is increased and is lower when the rotational speed of the indoor fan motor 104 is decreased. As a result, in a case where the calculated sensible heat ratio is lower than the target sensible heat ratio, the controller 2 increases the rotational speed of the indoor fan motor 104 by a rotational speed Ar set in advance (step S3) and thereby brings the sensible heat ratio closer to the target sensible heat ratio.

Then, the controller 2 judges whether the rotational speed of the indoor fan motor 104, after being increased by the rotational speed Ar, reaches the maximum rotational speed, which is set in advance (step S4). The maximum rotational speed set in advance refers to the maximum rotational speed of the apparatus. The controller 2 decreases the operating frequency of the compressor 201 if the rotational speed of the indoor fan motor 104 reaches the maximum rotational speed (step S5). That is, in a case where the rotational speed of the indoor fan motor 104 reaches the maximum rotational speed, further control of the indoor fan motor 104 no longer brings the sensible heat ratio any closer to the target sensible heat ratio. As no further adjustment is possible, the controller 2 controls the operating frequency of the compressor 201. Here, the sensible heat ratio decreases if the operating frequency of the compressor 201 increases and increases if the operating frequency of the compressor 201 decreases. For this reason, in a case where the rotational speed of the indoor fan motor 104 reaches the maximum rotational speed, the controller 2 decreases the operating frequency of the compressor 201 and thereby increases the sensible heat ratio and brings it closer to the target sensible heat ratio. On the other hand, in step S4, if the rotational speed of the indoor fan motor 104 does not reach the maximum rotational speed, the controller 2 ends the first control.

In step S2, in a case where the calculated sensible heat ratio is higher than the target sensible heat ratio, the controller 2 decreases the rotational speed of the indoor fan motor 104 by the rotational speed Ar, which is set in advance (step S6). Then, the controller 2 judges whether the rotational speed of the indoor fan motor 104, after being decreased by the rotational speed Ar, reaches the minimum rotational speed, which is set in advance (step S7). The minimum rotational speed set in advance refers to the minimum rotational speed of the apparatus. The controller 2 increases the operating frequency of the compressor 201 if the rotational speed of the indoor fan motor 104 reaches the minimum rotational speed (step S8). That is, in a case where the rotational speed of the indoor fan motor 104 reaches the minimum rotational speed, further control of the indoor fan motor 104 no longer brings the sensible heat ratio any closer to the target sensible heat ratio. As no further adjustment is possible, the controller 2 controls the operating frequency of the compressor 201. On the other hand, in step S7, if the rotational speed of the indoor fan motor 104 does not reach the minimum rotational speed, the controller 2 ends the first control.

In step S2, in a case where the calculated sensible heat ratio equals the target sensible heat ratio, the controller 2 maintains the current rotational speed of the indoor fan motor 104 (step S9) and ends the first control.

### Second Control

The controller 2 ends the first control described above and then performs the second control. The controller 2 calculates the current capacity value through the same method described above (step S11). The controller 2 compares the calculated capacity value with the target capacity value, which is set in advance (step S12) and controls the operating frequency of the compressor 201 according to a comparison result as described below (step S13 to step S15). Here, the capacity value increases when the operating frequency of the compressor 201 is increased and decreases when the operating frequency of the compressor 201 is decreased. As a result, in a case where the calculated capacity value is lower than the target capacity value, the controller 2 increases the operating frequency of the compressor 201 by an operating frequency Δf set in advance (step S13) and thereby brings the capacity value closer to the target capacity value.

In step S12, in a case where the calculated capacity value is higher than the target capacity value, the controller 2 decreases the operating frequency of the compressor 201 by the operating frequency Δf, which is set in advance, (step S14) and thereby brings the capacity value closer to the target capacity value.

In step S12, in a case where the calculated capacity value equals the target capacity value, the controller 2 maintains the current operating frequency of the compressor 201 (step S15) and ends the second control.

After the end of the second control described above, the controller 2 performs the first control and the second control again at the next control timing. In other words, the controller 2 repeatedly performs the first control and the second control at each control interval. Therefore, the air-conditioning apparatus 1 provides comfort to a user by enabling the sensible heat ratio of the indoor unit 100 to reach the target sensible heat ratio and also reduces power consumption by enabling the capacity value to reach the target capacity value.

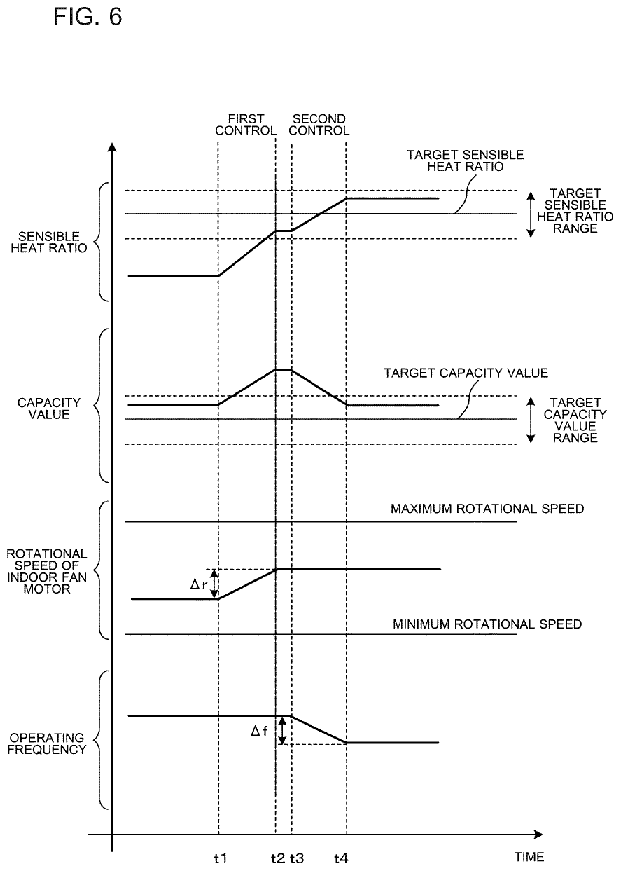

FIG. 6 is a time chart that illustrates the sensible heat ratio and the capacity value of the indoor unit 100, the rotational speed of the indoor fan motor 104, and the operating frequency of the compressor 201 in a dehumidifying operation of the air-conditioning apparatus 1 according to Embodiment 1. In FIG. 6, a target sensible heat ratio range is a range that includes the target sensible heat ratio. When the target sensible heat ratio is, for example, 0.8, the target sensible heat ratio range is set to, for example, 0.8±0.05. The air-conditioning apparatus 1 judges that the sensible heat ratio of the indoor unit 100 reaches the target sensible heat ratio when the sensible heat ratio enters the target sensible heat ratio range. The same applies to the case of a target capacity value as well. The target capacity value range is a range that includes the target capacity value. When the target capacity value is, for example, 5 kW, the target capacity value range is set to, for example, 5±0.5. The air-conditioning apparatus 1 judges that the capacity value reaches the target capacity value when the capacity value enters the target capacity value range. Note that the value ranges described above are examples and are not limited to the values described above.

FIG. 6 illustrates, as a simple example, an example in which the air-conditioning apparatus 1 performs the first control and the second control once each so that the sensible heat ratio reaches the target sensible heat ratio and the capacity value also reaches the target capacity value. As illustrated in FIG. 6, the air-conditioning apparatus 1 starts a dehumidifying operation and performs the first control at time t1. At the time t1, the sensible heat ratio is lower than the target sensible heat ratio range. For this reason, the air-conditioning apparatus 1 increases the rotational speed of the indoor fan motor 104 in the first control. At this time, the air-conditioning apparatus 1 maintains the operating frequency of the compressor 201 unchanged.

The air-conditioning apparatus 1 thus increases the rotational speed of the indoor fan motor 104 and, as a result, the capacity value increases. Then, at time t2 until which the rotational speed of the indoor fan motor 104 increases by Ar, the rotational speed of the indoor fan motor 104 does not reach the maximum rotational speed and the air-conditioning apparatus 1 thus ends the first control and, after switching time, enters the second control at time t3. Note that FIG. 6 illustrates the switching time provided from the first control to the second control; however, the switching time may also be provided or may also not be provided.

At the time t3, the capacity value is higher than the target capacity value range.

For this reason, the air-conditioning apparatus 1 decreases the operating frequency of the compressor 201 in the second control. The air-conditioning apparatus 1 thus decreases the operating frequency of the compressor 201 and, as a result, the capacity value decreases and the sensible heat ratio also increases. Then, in the air-conditioning apparatus 1, at time t4 at which the operating frequency of the compressor 201 decreases by Δf, the capacity value reaches the target capacity value. Also, at the time t4, the sensible heat ratio remains in a state where it has reached the target sensible heat ratio.

### Advantageous Effects of Air-Conditioning Apparatus 1

The air-conditioning apparatus 1 of Embodiment 1 is an air-conditioning apparatus provided with the outdoor unit 200, which has the compressor 201 and the outdoor heat exchanger 203, and the indoor unit 100, which is installed in an air-conditioning target space and has the indoor heat exchanger 101. The air-conditioning apparatus 1 is provided with the indoor fan 103, which is installed in the indoor unit 100 and sends out air to an air-conditioning target space, the indoor fan motor 104, which is installed in the indoor unit 100 and drives the indoor fan 103, and the controller 2, which controls the indoor fan motor 104 and the compressor 201. During a dehumidifying operation in which the outdoor heat exchanger 203 is caused to serve as a condenser and the indoor heat exchanger 101 is caused to serve as an evaporator, the controller 2 performs the first control in which the rotational speed of the indoor fan motor 104 and the operating frequency of the compressor 201 are controlled such that the sensible heat ratio of the indoor unit 100 matches the target sensible heat ratio, which is set in advance, and then performs the second control in which the operating frequency of the compressor 201 is controlled such that the capacity value of the indoor unit 100 matches the target capacity value, which is set in advance. The controller 2 performs the first control and the second control at once each or repeatedly performs the first control and the second control.

As specific control, in the first control, the controller 2 increases the rotational speed of the indoor fan motor 104 in a case where the sensible heat ratio of the indoor unit 100 is lower than the target sensible heat ratio and decreases the rotational speed of the indoor fan motor 104 in a case where the sensible heat ratio of the indoor unit 100 is higher than the target sensible heat ratio. In a case where the controller 2 increases the rotational speed of the indoor fan motor 104 and then the rotational speed of the indoor fan motor 104 reaches the maximum rotational speed, the controller 2 decreases the operating frequency of the compressor 201. In a case where the controller 2 decreases the rotational speed of the indoor fan motor 104 and then the rotational speed of the indoor fan motor 104 reaches the minimum rotational speed, the controller 2 increases the operating frequency of the compressor 201. In the second control, the controller 2 increases the operating frequency of the compressor 201 in a case where the capacity value of the indoor unit 100 is lower than the target capacity value and decreases the operating frequency of the compressor 201 in a case where the capacity value of the indoor unit 100 is higher than the target capacity value.

With the configuration described above, the air-conditioning apparatus 1 performs the first control and the second control once each or repeatedly performs the first control and the second control in a dehumidifying operation and thus controls the indoor fan motor 104 and the compressor 201 such that the sensible heat ratio of the indoor unit 100 matches the target sensible heat ratio and the capacity value of the indoor unit 100 matches the target capacity value. Therefore, the air-conditioning apparatus 1 achieves both improved comfort and reduced power consumption during a dehumidifying operation.

Note that the air-conditioning apparatus 1 uses the set relative humidity as a relative humidity required to calculate the sensible heat ratio. The air-conditioning apparatus 1 may also have a configuration provided with a humidity sensor and use the relative humidity measured at the humidity sensor to calculate the sensible heat ratio. However, in a case where the air-conditioning apparatus 1 is provided with a humidity sensor, the air-conditioning apparatus 1 accordingly incurs higher costs. For this reason, the air-conditioning apparatus 1 that uses the set relative humidity to calculate the sensible heat ratio is configured at lower costs.

### Embodiment 2

The air-conditioning apparatus 1 of Embodiment 2 differs from that of Embodiment 1 in the number of the indoor units 100 connected to the outdoor unit 200. The air-conditioning apparatus 1 of Embodiment 1 described above has a configuration in which one indoor unit 100 is connected to one outdoor unit 200. The air-conditioning apparatus 1 of Embodiment 2 has a configuration in which a plurality of indoor units 100 are connected to one outdoor unit 200. Configurations of Embodiment 2 that differ from those of Embodiment 1 are mainly described below.

Configurations that are not described in Embodiment 2 are the same as those of Embodiment 1.

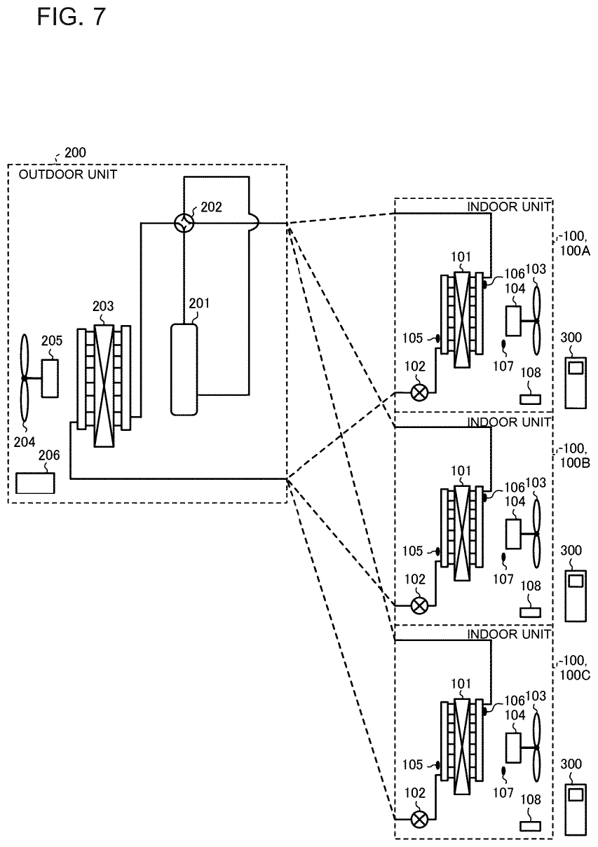

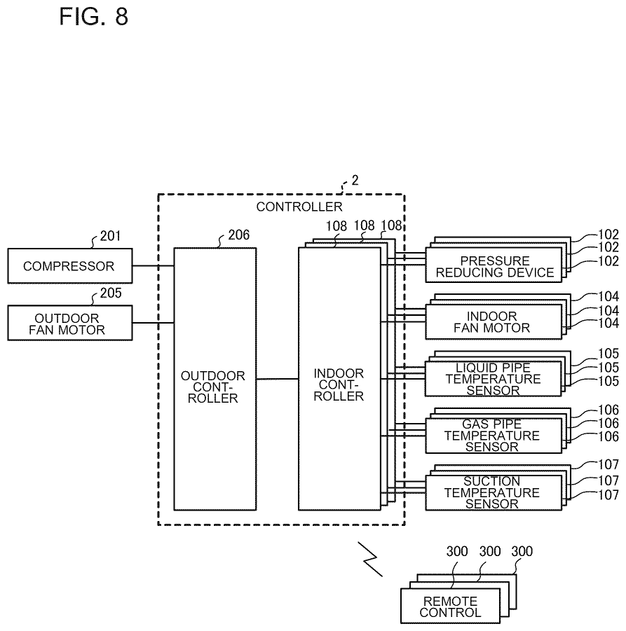

FIG. 7 is a diagram that illustrates the configuration of the air-conditioning apparatus 1 according to Embodiment 2. FIG. 8 is a control block diagram that illustrates the control configuration of the air-conditioning apparatus 1 according to Embodiment 2. In the air-conditioning apparatus 1 of Embodiment 2, three indoor units 100A, 100B, and 100C (hereinafter, may be collectively referred to as the indoor unit 100) are connected to one outdoor unit 200. The respective indoor units 100A, 100B, and 100C are installed in separate air-conditioning target spaces, which differ from each other. The number of the indoor units 100 is not limited to three and need only be larger than one. The controller 2 has the respective indoor controllers 108 installed in the separate indoor units 100 and the outdoor controller 206. In each of the indoor controllers 108, the target sensible heat ratio, which is common to all the indoor units 100, and the target capacity value, which is set according to the type of the corresponding one of the indoor units 100 are stored.

### Overview of Dehumidifying Operation Control

Similarly to Embodiment 1, during a dehumidifying operation, the air-conditioning apparatus 1 of Embodiment 2 performs the first control in which the indoor fan motors 104 and the compressor 201 are controlled such that the sensible heat ratio of each of the indoor units 100 matches the target sensible heat ratio and the second control in which the compressor 201 is controlled such that the capacity value matches the target capacity value. Here, the first control of Embodiment 2 has a first process and a second process. The first process is a process that controls the indoor fan motor 104 of each of all the indoor units 100 such that the calculated sensible heat ratio of the indoor unit 100 matches the target sensible heat ratio. The second process is a process that controls the compressor 201 such that a representative sensible heat ratio that has the highest value among the calculated sensible heat ratios of all the indoor units 100 matches the target sensible heat ratio.

Also, the second control of Embodiment 2 is control that controls the compressor 201 such that the calculated capacity value of a representative indoor unit among all the indoor units 100 matches the target capacity value set according to the type of the representative indoor unit. The method for determining the representative indoor unit is described later. The air-conditioning apparatus 1 repeatedly performs the first control and the second control so that the sensible heat ratio of each of the indoor units 100 reaches the target sensible heat ratio and the capacity value also reaches the target capacity value and thereby achieves both improved comfort and reduced power consumption.

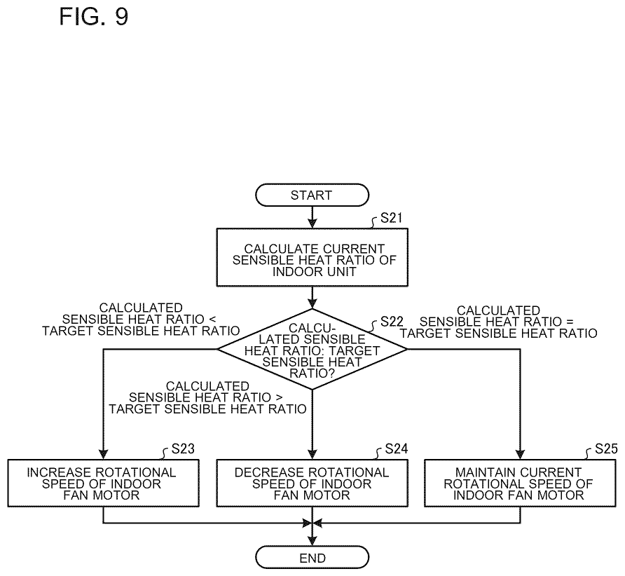

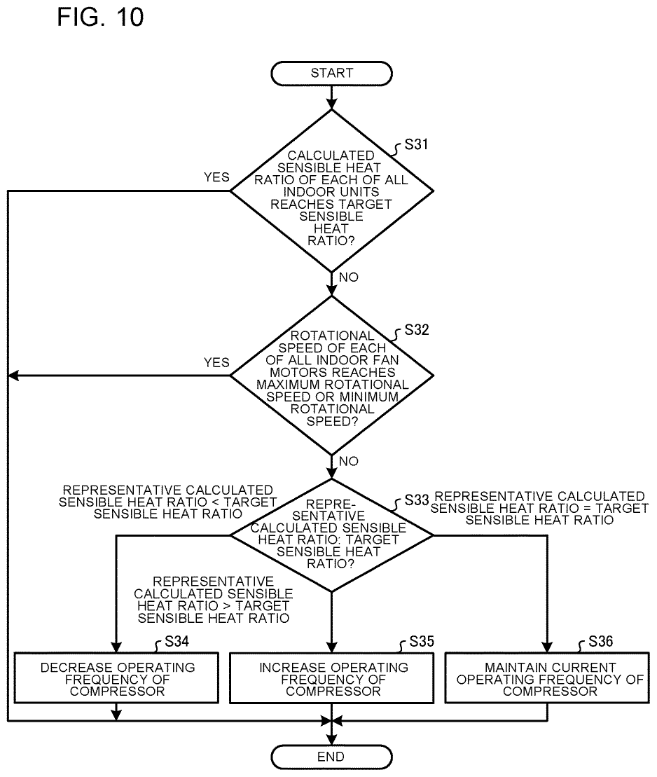

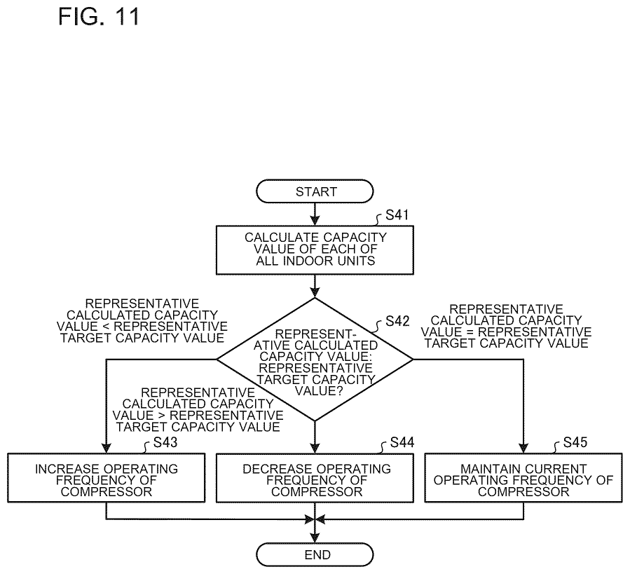

FIG. 9 is a flowchart that illustrates the first process in the first control in a dehumidifying operation of the air-conditioning apparatus 1 according to Embodiment 2. FIG. 10 is a flowchart that illustrates the second process in the first control in a dehumidifying operation of the air-conditioning apparatus 1 according to Embodiment 2. FIG. 11 is a flowchart that illustrates the second control in a dehumidifying operation of the air-conditioning apparatus 1 according to Embodiment 2. Processes described in the flowcharts illustrated in FIG. 9 to FIG. 11 are repeated at each control interval (for example, every minute). Note that the processes below are performed with communication between each of the indoor controllers 108 and the outdoor controller 206 as necessary; however, the processes are described below as being performed by the controller 2 without the indoor controller 108 and the outdoor controllers 206 distinguished from each other.

### First Control

The controller 2 performs the first process described below for each of the indoor units 100. The controller 2 calculates the current sensible heat ratio of the air-conditioning target space through the same method described above (step S21).

The controller 2 compares the calculated sensible heat ratio with the target sensible heat ratio, which is set in advance, (step S22) and controls the rotational speed of the indoor fan motor 104 according to a comparison result as described below (step S23, step S24, and step S25).

That is, in a case where the calculated sensible heat ratio is lower than the target sensible heat ratio, the controller 2 increases the rotational speed of the indoor fan motor 104 by Ar (step S23). In a case where the calculated sensible heat ratio is higher than the target sensible heat ratio, the controller 2 decreases the rotational speed of the indoor fan motor 104 by Ar (step S24). In a case where the calculated sensible heat ratio equals the target sensible heat ratio, the controller 2 maintains the current rotational speed of the indoor fan motor 104 (step S25).

Subsequently, the controller 2 performs the second process described below. The controller 2 judges whether the calculated sensible heat ratio of each of all the indoor units 100 reaches the target sensible heat ratio (step S31). If the calculated sensible heat ratio of each of all the indoor units 100 reaches the target sensible heat ratio, the controller 2 ends the second process and thereby ends the first control. If the calculated sensible heat ratio of each of all the indoor units 100 does not reach the target sensible heat ratio, the controller 2 subsequently judges whether the rotational speed of each of all the indoor fan motors 104 reaches the maximum rotational speed or the minimum rotational speed (step S32). If the rotational speed of each of all the indoor fan motors 104 reaches the maximum rotational speed or the minimum rotational speed, the controller 2 ends the second process and thereby ends the first control.

If the calculated sensible heat ratio of each of all the indoor units 100 does not reach the target sensible heat ratio in step S31 and the rotational speed of each of all the indoor fan motors 104 does not reach the maximum rotational speed or the minimum rotational speed in step S32, the controller 2 compares a representative calculated sensible heat ratio with the target sensible heat ratio (step S33). The controller 2 determines the highest calculated sensible heat ratio from the calculated sensible heat ratios of all the indoor units 100 as the representative calculated sensible heat ratio. That is, the controller 2 determines the sensible heat ratio of the indoor unit 100 that is currently not sufficiently dehumidified as the representative calculated sensible heat ratio. The reason for this determination is described later.

In a case where the representative calculated sensible heat ratio is lower than the target sensible heat ratio, the controller 2 decreases the operating frequency of the compressor 201 (step S34) and then ends the second process. In a case where the representative calculated sensible heat ratio is higher than the target sensible heat ratio, the controller 2 increases the operating frequency of the compressor 201 (step S35) and then ends the second process. In a case where the representative calculated sensible heat ratio equals the target sensible heat ratio, the controller 2 maintains the current operating frequency of the compressor 201 (step S36) and then ends the second process.

Here, the controller 2 determines the sensible heat ratio of the indoor unit 100 that is currently not sufficiently dehumidified as the representative calculated sensible heat ratio. The reason is as follows. In a case where the controller 2 determines the lowest calculated sensible heat ratio as the representative calculated sensible heat ratio, when the representative calculated sensible heat ratio is lower than the target sensible heat ratio in the comparison process of step S33, the operating frequency of the compressor 201 decreases in the process of step S34. In this case, sufficient dehumidification may not be achieved and comfort may also not be ensured in other air-conditioning target spaces. Therefore, the controller 2 determines the highest calculated sensible heat ratio as the representative calculated sensible heat ratio.

The controller 2 brings the sensible heat ratio of each of the indoor units 100 closer to the target sensible heat ratio through the first control, which has the first process and the second process, which are described above.

### Second Control

The controller 2 ends the first control described above and then performs the second control. The controller 2 calculates the capacity value of each of all the indoor units 100 (step S41). The capacity value is calculated through the same method described above. Then, the controller 2 controls the compressor 201 such that the representative calculated capacity value, which is the calculated capacity value of a representative indoor unit among all the indoor units 100, matches the representative target capacity value, which is the target capacity value set according to the type of the representative indoor unit (step S42 to step S45).

Here, in a case where all the indoor units 100 each have a calculated capacity value higher than the target capacity value set according to the type of the indoor unit 100, the indoor unit with the calculated capacity value that has the smallest difference from the target capacity value is determined as the representative indoor unit. In other cases, that is, in a case where one or some of the indoor units 100 each have a calculated capacity value lower than the target capacity value set according to the type of the indoor unit 100, the indoor unit described below is determined as the representative indoor unit. That is, the indoor unit among all the indoor units 100 that has the calculated capacity value that is lower than the target capacity value set according to the type of the indoor unit and has the largest difference from the target capacity value is determined as the representative indoor unit.

Such selection of the representative indoor unit is described below with a specific example. For example, a case is described below where the calculated capacity value is 23 kW and the target capacity value is 20 kW for the indoor unit 100A, the calculated capacity value is 31 kW and the target capacity value is 30 kW for the indoor unit 100B, and the calculated capacity value is 42 kW and the target capacity value is 40 kW for the indoor unit 100C. In this case, all the plurality of indoor units 100 each have a calculated capacity value higher than the target capacity value set according to the type of the indoor unit 100 and the indoor unit 100B, which has the calculated capacity value with the smallest difference from the target capacity value, is determined as the representative indoor unit. In this case, the representative calculated capacity value is 31 kW and the representative target capacity value is 30 kW.

As another example, a case is described below where the calculated capacity value is 23 kW and the target capacity value is 20 kW for the indoor unit 100A, the calculated capacity value is 27 kW and the target capacity value is 30 kW for the indoor unit 100B, and the calculated capacity value is 35 kW and the target capacity value is 40 kW for the indoor unit 100C. In this case, the indoor unit 100B and the indoor unit 100C each have a calculated capacity value lower than the target capacity value set for the corresponding indoor unit. For this reason, the indoor unit 100C, which has the calculated capacity value with the largest difference from the target capacity value, is determined as the representative indoor unit. In this case, the representative calculated capacity value is 35 kW and the representative target capacity value is 40 kW.

The controller 2 compares the representative calculated capacity value, which is the calculated capacity value of the representative indoor unit, with the representative target capacity value in step S42. In a case where the representative calculated capacity value is lower than the representative target capacity value, the controller 2 increases the operating frequency of the compressor 201 by Δf (step S43). In a case where the representative calculated capacity value is higher than the representative target capacity value, the controller 2 decreases the operating frequency of the compressor 201 by Δf (step S44). In a case where the representative calculated capacity value equals the representative target capacity value, the controller 2 maintains the current operating frequency of the compressor 201 (step S45).

After the end of the second control described above, the controller 2 performs the first control and the second control again at the next control timing. In other words, the controller 2 repeatedly performs the first control and the second control at each control interval. Therefore, the air-conditioning apparatus 1 enables the sensible heat ratio of each of the all the indoor units 100 to reach the target sensible heat ratio and also enables the capacity of each of the all the indoor units 100 to reach the target capacity value.

As described above, the air-conditioning apparatus 1 of Embodiment 2 is provided with the plurality of indoor units 100 installed in separate air-conditioning target spaces, which differ from each other. The controller 2 has the target sensible heat ratio, which is common to all the indoor units 100, and the target capacity value, which is set according to the type of each of all the indoor units 100. The first control is control that has the first process that controls the indoor fan motor 104 of each of all the indoor units 100 such that the sensible heat ratio of the indoor unit 100 matches the target sensible heat ratio and the second process that controls the compressor 201 such that a representative sensible heat ratio that has the highest value among the sensible heat ratios of all the indoor units 100 matches the target sensible heat ratio. The second control is control that controls the compressor 201 such that the capacity value of the representative indoor unit 100 among all the indoor units 100 matches the representative target capacity value, which is the target capacity value set according to the type of the representative indoor unit 100. The representative indoor unit 100 is the indoor unit 100 that has the capacity value with the smallest difference from the target capacity value in a case where all the indoor units 100 each have a capacity value higher than the target capacity value set according to the type of the indoor unit 100. In other cases, the representative indoor unit 100 is the indoor unit 100 that has the capacity value that is lower than the target capacity value set according to the type of the indoor unit 100 and has the largest difference from the target capacity value.

As specific control, in the first process in the first control, the controller 2 increases the rotational speed of the indoor fan motor 104 in a case where the sensible heat ratio is lower than the target sensible heat ratio and decreases the rotational speed of the indoor fan motor 104 in a case where the sensible heat ratio is higher than the target sensible heat ratio. In the second process in the first control, in a case where the sensible heat ratio of each of all the indoor units 100 does not reach the target sensible heat ratio and the rotational speed of each of all the indoor fan motors 104 does not reach the maximum rotational speed, which is set in advance, or the minimum rotational speed, which is set in advance, and, furthermore, the representative sensible heat ratio is lower than the target sensible heat ratio, the controller 2 decreases the operating frequency of the compressor 201. In the second process in the first control, in a case where the sensible heat ratio of each of all the indoor units 100 does not reach the target sensible heat ratio and the rotational speed of each of all the indoor fan motors 104 does not reach the maximum rotational speed or the minimum rotational speed and, furthermore, the representative sensible heat ratio is higher than the target sensible heat ratio, the controller 2 increases the operating frequency of the compressor 201. In the second control, the controller 2 increases the operating frequency of the compressor 201 in a case where the representative capacity value is lower than the representative target capacity value and decreases the operating frequency of the compressor 201 in a case where the representative capacity value is higher than the representative target capacity value.

With the configuration described above, the air-conditioning apparatus 1 of Embodiment 2 even provided with the plurality of indoor units 100 installed in separate air-conditioning target spaces, which differ from each other, obtains the same advantageous effects as in Embodiment 1.

### REFERENCE SIGNS LIST

1: air-conditioning apparatus, 2: controller, 100: indoor unit, 100A: indoor unit, 100B: indoor unit, 100C: indoor unit, 101: indoor heat exchanger, 102: pressure reducing device, 103: indoor fan, 104: indoor fan motor, 105: liquid pipe temperature sensor, 106: gas pipe temperature sensor, 107: suction temperature sensor, 108:
indoor controller, 200: outdoor unit, 201: compressor, 202: four-way valve, 203:
   outdoor heat exchanger, 204: outdoor fan, 205: outdoor fan motor, 206: outdoor controller, 300: remote control

1. An air-conditioning apparatus provided with an outdoor unit that has a compressor and an outdoor heat exchanger and an indoor unit that is installed in an air-conditioning target space and has an indoor heat exchanger, comprising:
an indoor fan installed in the indoor unit and configured to send out air to the air-conditioning target space;
an indoor fan motor installed in the indoor unit and configured to drive the indoor fan; and
a controller configured to control the indoor fan motor and the compressor,
during a dehumidifying operation in which the outdoor heat exchanger is caused to serve as a condenser and the indoor heat exchanger is caused to serve as an evaporator, the controller being configured to perform a first control in which a rotational speed of the indoor fan motor and an operating frequency of the compressor are controlled such that a sensible heat ratio of the indoor unit matches a target sensible heat ratio, which is set in advance, and being then configured to perform a second control in which the operating frequency of the compressor is controlled such that a capacity value of the indoor unit matches a target capacity value, which is set in advance.

2. The air-conditioning apparatus of claim 1, wherein the controller is configured to repeatedly perform the first control and the second control.

3. The air-conditioning apparatus of claim 1, wherein,
in the first control,
the controller is configured to increase the rotational speed of the indoor fan motor in a case where the sensible heat ratio of the indoor unit is lower than the target sensible heat ratio and to decrease the rotational speed of the indoor fan motor in a case where the sensible heat ratio of the indoor unit is higher than the target sensible heat ratio,
the controller is configured to decrease the operating frequency of the compressor in a case where the controller increases the rotational speed of the indoor fan motor and then the rotational speed of the indoor fan motor reaches a maximum rotational speed, which is set in advance, and
the controller is configured to increase the operating frequency of the compressor in a case where the controller decreases the rotational speed of the indoor fan motor and then the rotational speed of the indoor fan motor reaches a minimum rotational speed, which is set in advance, and
in the second control,
the controller is configured to increase the operating frequency of the compressor in a case where the capacity value of the indoor unit is lower than the target capacity value and to decrease the operating frequency of the compressor in a case where the capacity value of the indoor unit is higher than the target capacity value.

4. The air-conditioning apparatus of claim 1, wherein,
the indoor unit comprises a plurality of indoor units installed in the separate air-conditioning target spaces, which differ from each other,
the controller has a target sensible heat ratio, which is set in advance, that is common to all the plurality of indoor units and a target capacity value that is set according to a type of a corresponding one of all the plurality of indoor units,
the first control is control that has a first process that controls the rotational speed of the indoor fan motor of each of all the plurality of indoor units such that the sensible heat ratio of the indoor unit matches the target sensible heat ratio and a second process that controls the operating frequency of the compressor such that a representative sensible heat ratio that has a highest value among the sensible heat ratios of all the plurality of indoor units matches the target sensible heat ratio,
the second control is control that controls the operating frequency of the compressor such that a representative capacity value that is the capacity value of a representative indoor unit among all the plurality of indoor units matches a representative target capacity value that is the target capacity value set according to a type of the representative indoor unit,
the representative indoor unit is an indoor unit that has a capacity value with a smallest difference from the target capacity value in a case where all the plurality of indoor units each have a capacity value higher than the target capacity value set according to a type of the indoor unit, and
in other cases, the representative indoor unit is an indoor unit that has a capacity value that is lower than the target capacity value set according to a type of the indoor unit and has a largest difference from the target capacity value.

5. The air-conditioning apparatus of claim 4, wherein,
in the first process in the first control,
the controller is configured to increase the rotational speed of the indoor fan motor in a case where the sensible heat ratio is lower than the target sensible heat ratio and to decrease the rotational speed of the indoor fan motor in a case where the sensible heat ratio is higher than the target sensible heat ratio,
in the second process in the first control,
the controller is configured to decrease the operating frequency of the compressor in a case where the sensible heat ratio of each of all the plurality of indoor units does not reach the target sensible heat ratio and the rotational speed of each of all the indoor fan motors does not reach a maximum rotational speed, which is set in advance, or a minimum rotational speed, which is set in advance, and, furthermore, the representative sensible heat ratio is lower than the target sensible heat ratio, and
the controller is configured to increase the operating frequency of the compressor in a case where the sensible heat ratio of each of all the plurality of indoor units does not reach the target sensible heat ratio and the rotational speed of each of all the indoor fan motors does not reach the maximum rotational speed or the minimum rotational speed and, furthermore, the representative sensible heat ratio is higher than the target sensible heat ratio, and
in the second control,
the controller is configured to increase the operating frequency of the compressor in a case where the representative capacity value is lower than the representative target capacity value and to decrease the operating frequency of the compressor in a case where the representative capacity value is higher than the representative target capacity value.

6. The air-conditioning apparatus of claim 1, comprising:
a suction temperature sensor configured to measure a suction temperature of air sucked into the indoor unit; and
a liquid pipe temperature sensor provided to a liquid side of the indoor heat exchanger and configured to measure a temperature of refrigerant that flows through the indoor heat exchanger, wherein
the controller is configured to derive the sensible heat ratio according to the suction temperature measured by the suction temperature sensor, a liquid pipe temperature measured by the liquid pipe temperature sensor, the rotational speed of the indoor fan motor, and a set humidity set in advance.
